(19) United States
(12) Patent Application Publication
(10) Pub. No.: US 2015/0380932 A1
(43) Pub. Date: Dec. 31, 2015

(54) POWER LOCK

(71) Applicant: KARLE INNOVATION LTD., Edmonton (CA)

(72) Inventor: Shawn KARLE, Edmonton (CA)

(21) Appl. No.: 14/750,296

(22) Filed: Jun. 25, 2015

Related U.S. Application Data
(60) Provisional application No. 62/017,348, filed on Jun. 26, 2014.
(60) Provisional application No. 62/095,591, filed on Dec. 22, 2014.

(51) Int. Cl. H02J 3/00

(52) U.S. Cl. CPC H02J 3/00

(57) ABSTRACT

A power control system is provided, including a power control module having a controller configured to change to and from a first state operable to enable an electrical connection between a power source and a power receptacle sufficient to operate a load, and a second state operable to limit the voltage to the power receptacle to a power level greater than zero volts but insufficient voltage to operate the load; a receiver; and a processor, the processor configured to move the switch in response to a code received by the receiver from a transmitter associated with the load.

### RELATED APPLICATIONS

This application claims the benefit of U.S. Provisional Patent Application No. 62/017,348, filed Jun. 26, 2014 and U.S. Provisional Patent Application No. 62/095,591 filed Dec. 22, 2014, both of which are hereby incorporated by reference in their entirety.

### FIELD OF THE INVENTION

This invention relates controls for electrical outlets and means of controlling the outlets, and more specifically to systems for controlling access to such outlets.

### BACKGROUND OF THE INVENTION

Electrical outlets are generally available to anyone who can access the outlet. This can be a problem for outdoor outlets, in which users can potentially take advantage of available power paid for by others. As the use of electricity increases, for example through increased demand for electric cars, the likelihood of “theft” of electricity increases.

A typical home based electrical system includes a number of outlets, into which plugs can be inserted and electricity used without any restraint. Likewise, public locations, such as parkades, often have outlets into which users can plug devices.

What is needed is a system to allow users access to their indoor and outdoor electrical outlets with ease, while denying access to unauthorized users.

### SUMMARY OF THE INVENTION

A power lock is provided including an electrical load in electrical communication with a module, the module configured to transmit a code to a switch, the switch, on receiving the code, configured to connect the load to a power source.

A power control system is provided, including a power control module having a controller configured to change to and from a first state operable to enable an electrical connection between a power source and a power receptacle sufficient to operate a load, and a second state operable to limit the voltage to the power receptacle to a power level greater than zero volts but insufficient voltage to operate the load; a receiver; and a processor, the processor configured to move the switch in response to a code received by the receiver from a transmitter associated with the load. The controller, in the second state the power reaching the power receptacle is sufficient to operate the transmitter. The receiver is configured to receive the code wirelessly or to receive the code over the electrical connection. The transmitter may be powered by a battery. The transmitter may be positioned within the load or within an extension cord. The power control module and transmitter may be powered by the power source. The power control module may further include a communications interface for communicating with a computing device.

The power control module may be configured to compare power consumed by a load receiving power through the receptacle to a predetermined power consumption level and if the predetermined power consumption level is exceeded disable the electrical connection to the receptacle.

A power control system is provided, including an electrical load having a plug; and a transmitter, the transmitter configured to transmit a code to a receiver, the code associated with the load and the receiver associated with a module configured to allow power flow through a receptacle.

A power control system is provided including: an electrical load; a transmitter associated with the electrical load, the transmitter configured to transmit a code associated with the electrical load; and a power control module comprising a switch, and a receiver, the power control module configured to operate the switch to connect a power source to the electrical load on receipt of the code.

A power control system is provided including: a plurality of electrical loads; a connection to a first power source; a connection to a second power source; means to protect the power control system from overcurrent; and a controller, the controller configured so that should the first power source cease controlling power, the controller will selectively energize at least one of the plurality of loads using the second power source based on predetermined criteria.

A power control system is provided including: a power distribution module having a controller configured to electrically connect one or more power receptacles of a plurality of power receptacles, each switch configured to move from a first position operable to enable an electrical connection between a power source and the switch's corresponding power receptacle, and a second position operable to disable the connection between the power source and the switch's corresponding power receptacle; a receiver; and a processor, the processor configured to move one of the plurality of switches in response to a code received by the receiver from a transmitter associated with a load corresponding to one of the plurality of power receptacles. The power control system may include a metering module configured to monitor the power usage at each of said plurality of receptacles.

### DESCRIPTION OF THE FIGURES

FIG. 1 is a block diagram showing an embodiment of the invention.

FIG. 2 is a block diagram showing an alternative embodiment of the invention.

FIG. 3 is a block diagram showing an embodiment of a circuit control module according to the invention.

FIG. 4 is a block diagram showing an embodiment of a remote module according to the invention.

FIG. 5 is a block diagram showing an embodiment of the invention, for use with a plurality of power receptacles.

FIG. 6 is a block diagram showing an embodiment of the invention for use in a public space, such as a park.

FIG. 7 is a block diagram of the invention for use at a home, for example to power a block heater or an electric car.

FIG. 8 is a block diagram showing an alternative embodiment of the invention including a current protector.

FIG. 9 is a flow chart illustrating an embodiment of a method of power control according to the invention.

FIGS. 10 and 11 show embodiments of a circuit control system according to the invention to detect circuit faults throughout the entire circuit, such as open or short circuits.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

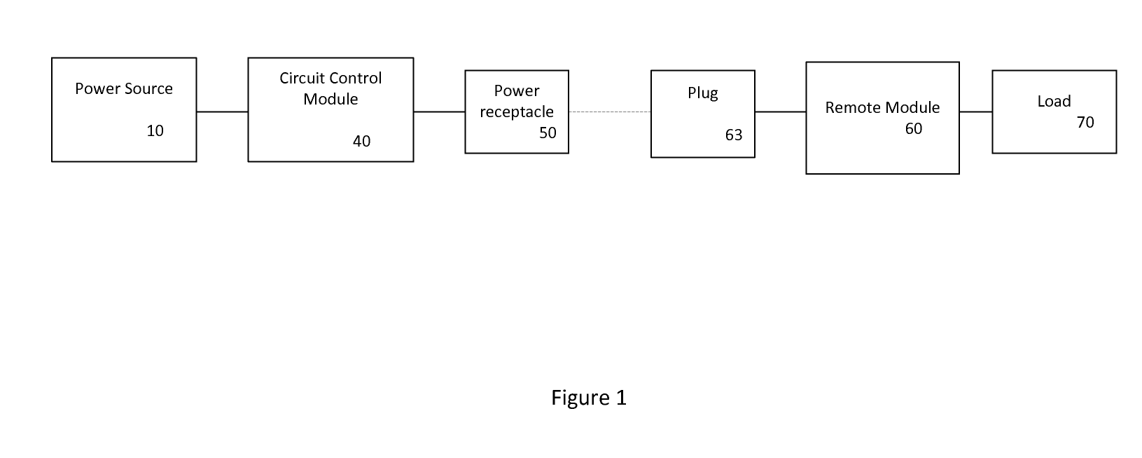

The power lock according to the invention provides means by which access to a power receptacle (also referred to as “power outlet”) can be controlled. In FIG. 1, an overview of the power lock environment is shown. Power source 10 has an electrical connection with, and delivers power to, circuit control module 40. Circuit control module 40 is in series between power source 10 and power receptacle 50, which is typically a female receptacle shaped to receive and hold plug 63.

Remote module 60 is associated with load 70 and may be powered through power source 10, in which case it has an electrical connection with power source 10 through plug 63. Remote module 60 is configured to transmit a code and an ID associated with remote module 60 to circuit control module 40 to allow circuit control module to provide electricity to power receptacle 50 and thereby to load 70. Remote module 60 is shown in series with load 70, but need not be in such an arrangement, and even could, for example, be portable for easy transportation by an individual.

Power source 10 may be a utility, a generator, battery or other source of electrical energy. Power receptacle 50 may be a typical AC socket, to receive two or three pins. Plug 63 is shaped to fit, and typically be held in position by, power receptacle 50, and to electrically connect with power receptacle 50 to allow electric power to flow from power source 10 to load 70.

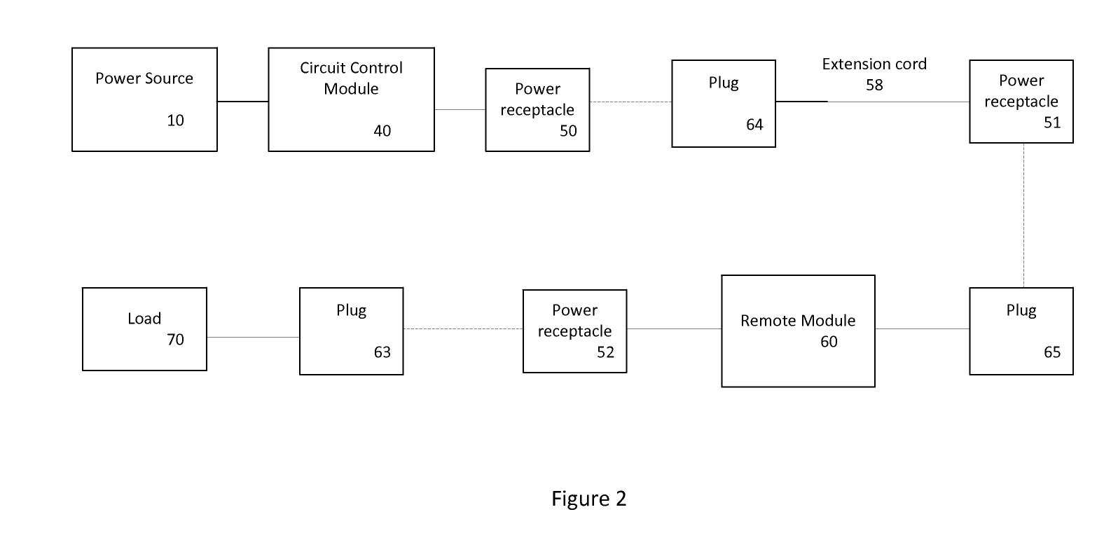

FIG. 2 shows an alternative arrangement of circuit control module 40 and remote module 60. In the arrangement shown in FIG. 1, remote module 60 is associated with load 70, so that while load 70 will be operable by using power receptacle 50, other loads may not be operable. For example if remote module is associated with a block heater, and the user wishes to use power receptacle to power a trimmer, the trimmer, not having a remote module, will not be operable.

In the embodiment shown in FIG. 2, remote module 60 is electrically connected to, and positionable to connect, both a power receptacle 52 and a plug 65. This enables remote module 60 to be placeable in series with a variety of loads 70 which connect to remote module through power receptacle 52. An optional extension cord 58 is shown with plug 64 and power receptacle 51. In an alternative embodiment, remote module may be part of extension cord 58.

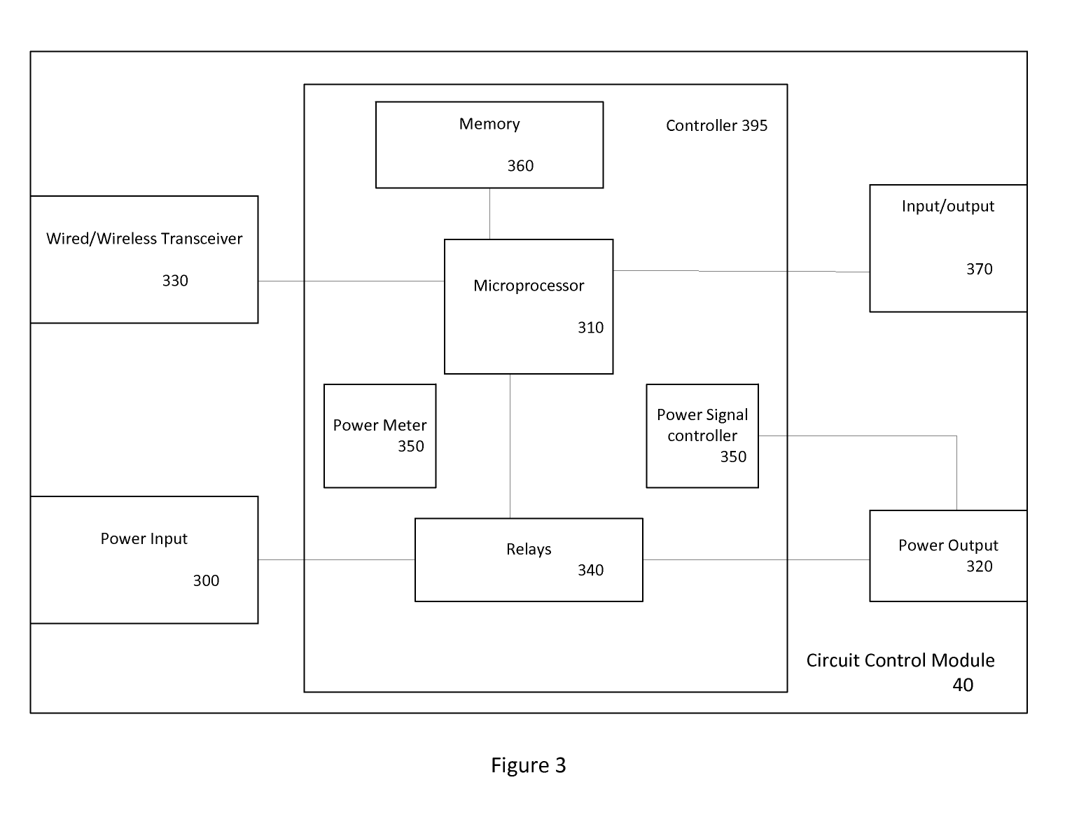

An embodiment of circuit control module 40 is shown in FIG. 3. Circuit control module 40 receives power from power source 10 through power input 300. Control module 40 also includes controller 395 and power output 320 (which has an electrical connection to power receptacle 50). Power output 320 may also be configured to send and receive signals along the power line using power line communications. These signals are extracted and input by power signal controller 350, which receives signals for input and sends signals received to microprocessor 310. Circuit control module 40 may be accessed via input/output 370. Input/output 370 may also include means of accessing circuit control module 40 by upload/download devices, such as pads, PCs, smart phones, laptops or specialized devices. Alternatively, instead of using power line communications, transceiver 330 may be used and is configured to receive signals from remote module 60.

Microprocessor 310 controls relays 340. In the case where a signal has not been received to allow power to flow to receptacle 50, relays 340 will limit the power passing to receptacle 50 to no more than 30 volts in an embodiment of the invention, or between 12 and 60 volts (AC or DC) in an alternative embodiment of the invention, which is sufficient to power remote module 60, but not to operate load 70. In an alternative embodiment relays 340 can block power flow to receptacle 50 completely until circuit module 40 receives the appropriate signal from remote module 60. Power meter 350 tracks the power usage.

Memory 360 includes operating instructions and can store electrical usage information, such as the amount of power used as recorded by power meter 350, and when and which codes are associated with the power use. Such information can be downloaded later for billing or other power use tracking purposes. Memory 360 also includes codes for comparison to codes received by transceiver 330 or power signal controller 350.

Relays 340 may allow a portion of the voltage from power source 10 to pass to power receptacle 50 and thereby power remote module 60. For example, relays 340 may allow, for example 24-30 volts, or 12 to 60 volts, or even 12 to 600 volts to pass through, depending on the load 70 for which power is being supplied. The power passing through should be sufficient to power remote module 60 but not enough to power load 70.

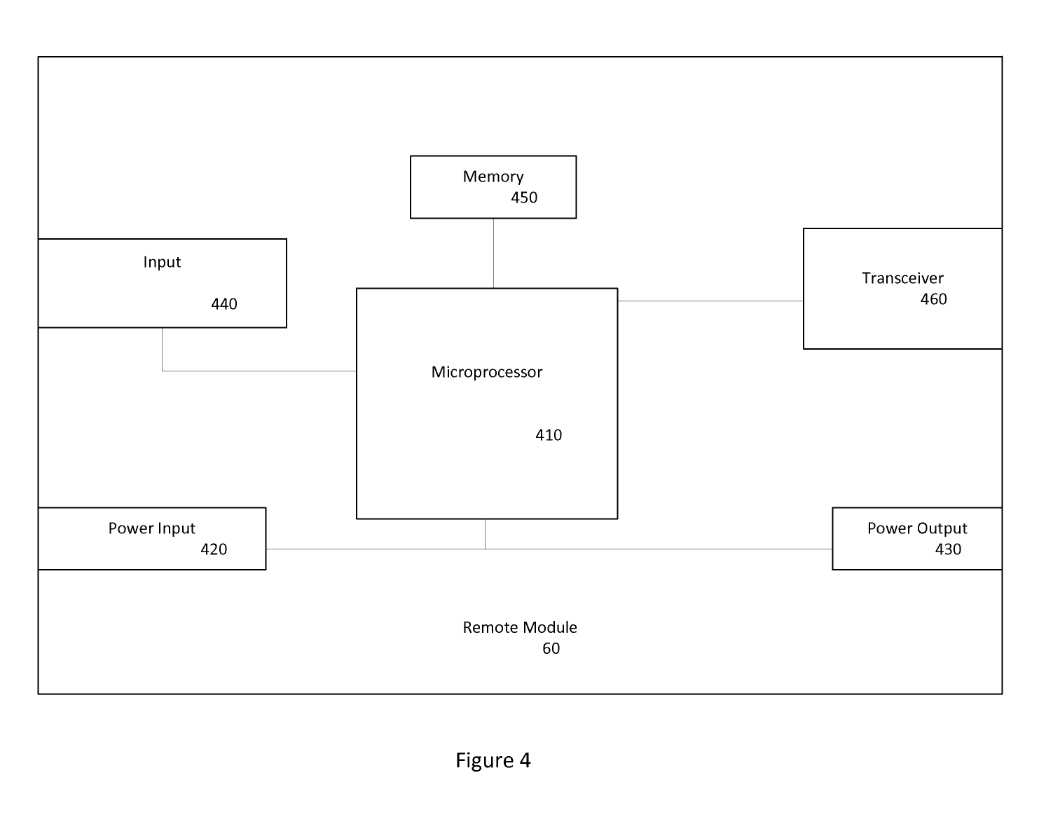

FIG. 4 shows an embodiment of a remote module 60 according to the invention. Remote module 60 includes microprocessor 410, memory 450; power input 420 (from power source 10 via plug 63) and power output 430 (for power flow to load 70). Remote module 60 may be accessed via input 440, which allows access by a device, such as a pad, smartphone, PC, or laptop. Transceiver 460 relays authorized codes stored in memory 450 in a matter that can be received and detected by receiver 330 on circuit control module 40. Transceiver 460 sends signals to control module 40, and may be a hard wired transceiver or a wireless transceiver or both. Remote module 60 may be powered by the circuit (i.e. from power source 10 as described above) or by a battery or by other means.

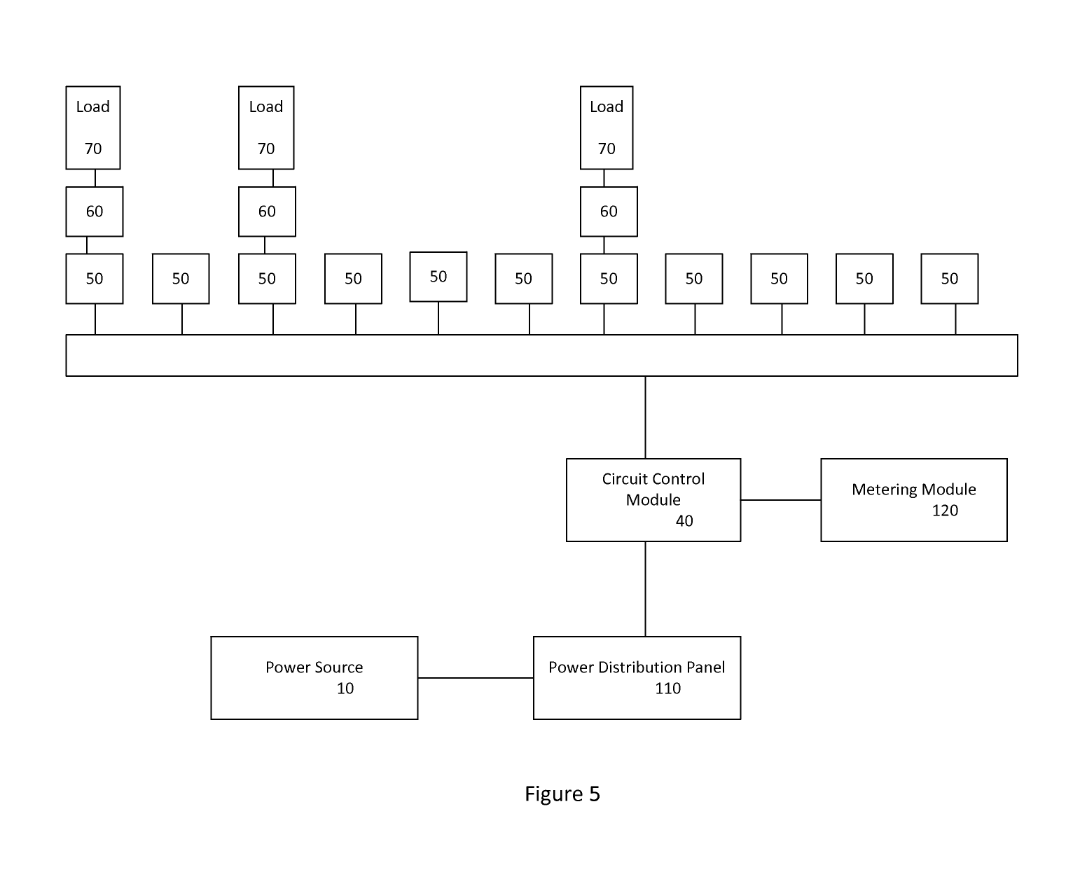

FIG. 5 shows an alternative embodiment of the invention for use in a public space where a plurality of power receptacles 50 are available for use, such as a parking lot. In this embodiment load 70 is typically a car or other vehicle. A remote module 60 is positioned between each load 70 and power receptacle 50 in order to use power receptacle 50. Given the number of parking stalls in parking lot, a plurality of power receptacles 50 are available, typically one for each parking stall.

Circuit control module 40 distributes power to power receptacles 50 from power source 10. Relays 340 in this embodiment of the power lock system are configured to send power to one, some or all of receptacles 50. Circuit control module 40 provides instructions to distribution panel 110. Circuit control module 40 receives communications, including a code and ID, from each remote module 60 and informs relays 340 which of the particular power receptacles 50 are to receive power, and thereby delivers power to those designated power receptacles 50. Distribution panel 110 also includes circuit protection devices, for example fuses or breakers.

Circuit control module 40 can be queried at intervals to determine when remote control module 60 has left or moved to another power receptacle 50. The code and ID should be sent by remote module 60 at periodic intervals, and if the code is not received after a certain time, power flow is restricted and reduced to preauthorization levels as noted above.

Metering module 120 can monitor power usage at each power receptacle 50 and thereby providing information about the authorized use of power receptacles 50 for a particular load 70 associated with the remote module 60 ID for billing or safety purposes. The metering module 120 can be in wireless or wired communication with circuit control module 40. Metering module 120 may include a clock or timer to cycle loads.

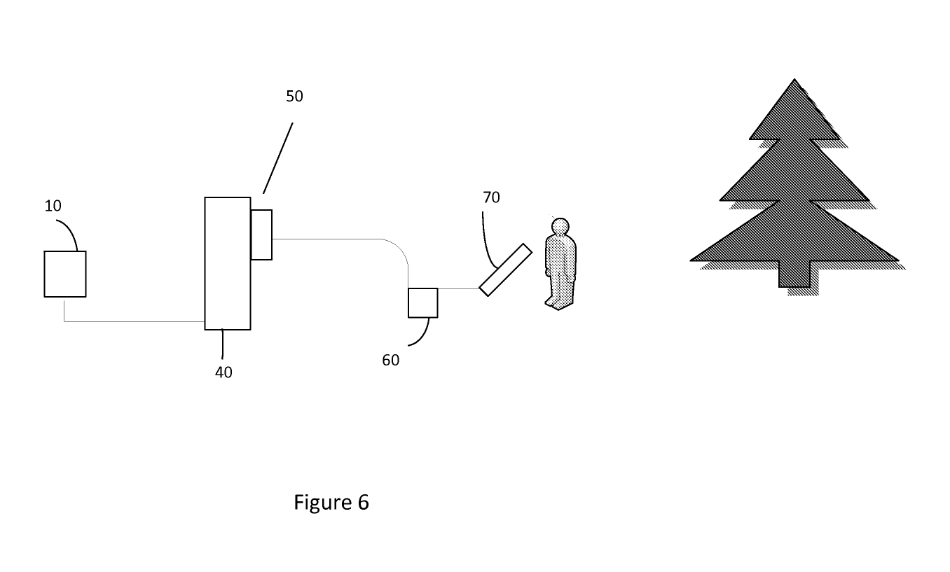

FIG. 6 shows an example of an embodiment of the system according to the invention for use in a park. In this embodiment power receptacle 50 is energized to a low voltage state as described above through circuit control module 40 until circuit control module 40 receives the appropriate signal from remote module 60. This system prevents unauthorized users from accessing and using power receptacles 50 in a public area, such as a park, without needing to limit access to power receptacle 50 using a locked cabinet or other physical measures.

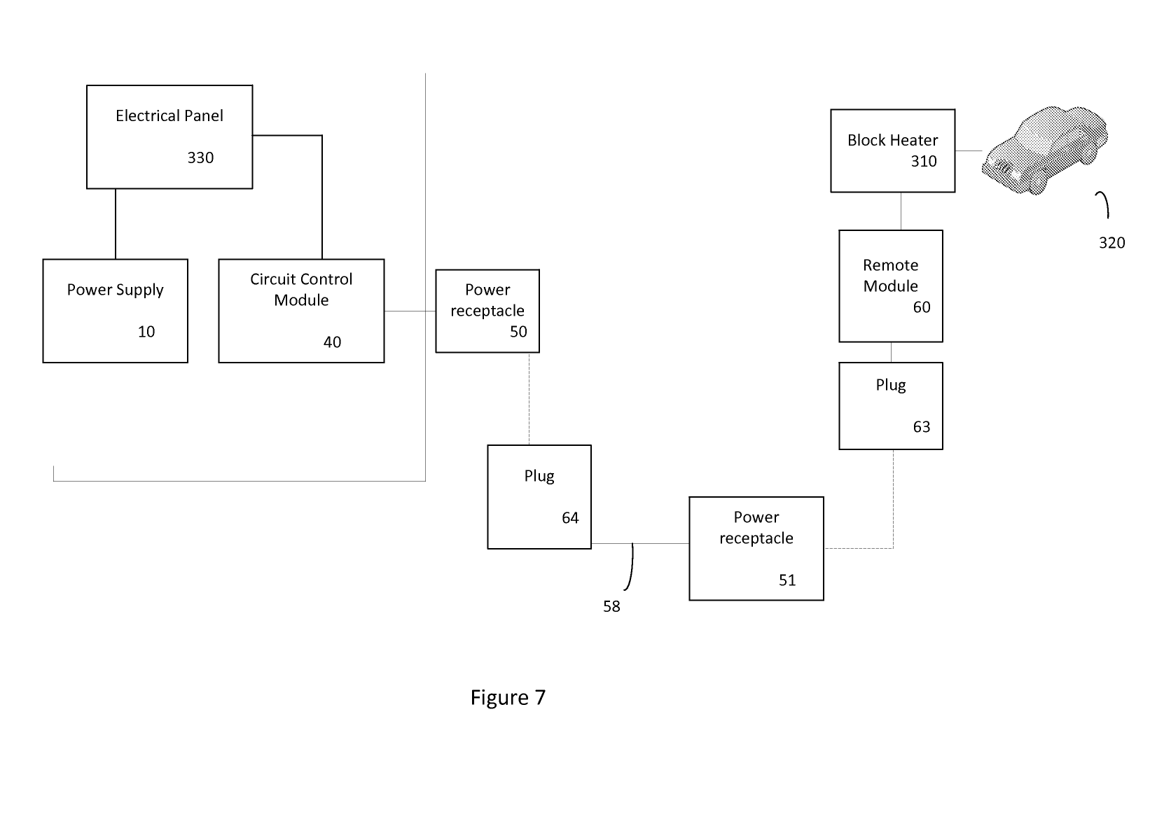

FIG. 7 shows an embodiment of the invention for use with a block heater 310 secured to a vehicle 320, although it could also be used to charge an electric car or otherwise provide power to or near vehicle 320. In the example shown, remote module 60 connects to block heater 310 on one end, and extension cord 58 on the other end. In this embodiment of the invention, remote module 60 may be installable under the hood of the car, and thus always be available and attached to block heater 310. Circuit control module 40 may be positioned near electrical panel 330.

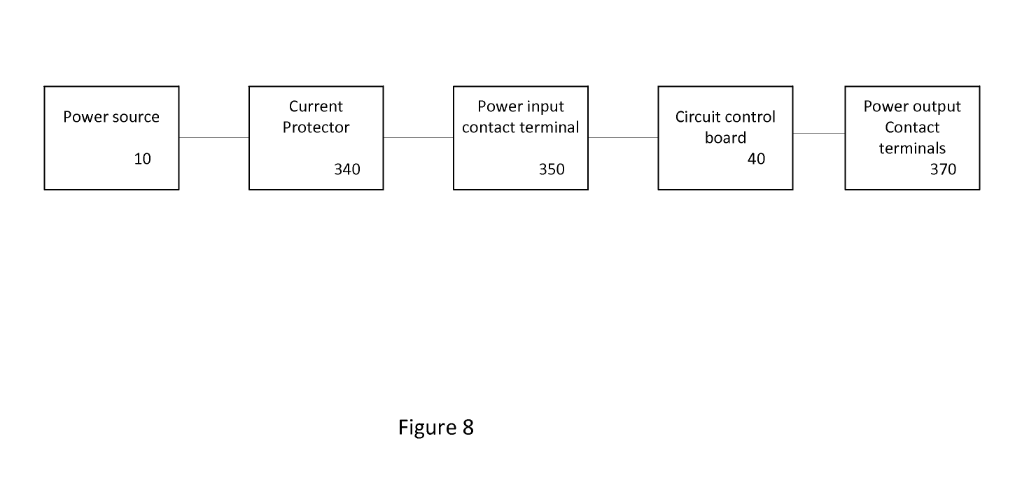

An alternative embodiment of a system according to the invention as shown in FIG. 8 includes current protector 340, which is positioned between power source 10 and power input contact terminal 350, which can transfer power to power output contact terminals 370 if instructed by circuit control module 40. Any number of output contact terminals 370 may be present. Current protector 340 may be any means of controlling a circuit, typically a breaker or fuse which provides basic over current and/or short circuit protection for a given circuit or load. Current protector 340 may be within circuit control module 40 or may be a separate unit. Circuit control module 40 monitors and authorizes, via the remote module 60, power receptacles 50. Circuit control module 40 may also communicate with a third party such as cloud servers, power line communication on the incoming power wires, wireless or any other means to control, read or monitor loads 70 or for any other reason.

Circuit control module 40 includes input/output 370, which provides Internet and/or network access. Input/output 370 may include a wireless transceiver which, besides providing Internet and/or network access, may be used to communicate with remote module 60. Alternatively, or in addition to a transceiver, input/output 370 may include a USB port, to allow direct communications with a user device, such as a laptop computer or pad (which alternatively can communicate via a network). A user may use a user device to program circuit control module 40 by uploading or downloading codes from and to remote modules 60, for example after purchase of a new remote module 60.

Remote module 60 may have a similar set of communication tools, including power input contacts, power output contacts, wireless antenna, and inputs, such as a USB port for user devices, for example a laptop, PC, pad or smartphone.

In an alternative embodiment of the invention, a compact version of the system according to the invention may be provided, wherein the components of circuit control module 40, including transceiver 330, relay 340, and microprocessor 310 are part of receptacle 50.

The power lock, according to the invention, allows power supplies 10 to be closed and connected to loads 70 to which remote modules 60 have authorized signals, codes or programmable signals which are communicated to circuit control module 40. The system thus prevents theft or unwanted use of power supplies 10. The system can also act as a controller to cycle or control authorized loads 70 on or off as may be required.

Circuit control module 40 may open/close access to power source 10 and allows authorized loads 70 to receive power. Circuit control module 40 is capable of uploading/downloading codes or tones for authorizing remote module 60 and may be capable of receiving wireless authorization from remote module 60. Alternatively, or in addition, circuit control module 40 may receive hard wired communications or authorization from remote module 60 or any other required source, such as a network controller or online application. Circuit control module 40 may be accessed remotely, using the Internet or network systems and may be connected locally to a laptop or similar device for uploading/downloading of codes and IDs or usage information.

The system according to the invention works in series and opens and closes a circuit. Circuit control module 40 draws power from power source 10 via the primary or live side of the circuit and sends and receives signals on the load 70 or deenergized side of the circuit to and from the corresponding remote module 60. In this process unused power receptacles 50 are maintained at a low voltage state which acts also as a safety device, however the low voltage supply from circuit control module 40 may be used to energize the remote modules 60, which when energized then send a programmed authorized code back to circuit control module 40, which can then energize the circuit if the correct code is received.

This signal sent by remote module 60 to circuit control module 40 can be, but is not limited to, a message that is transmitted the entire time load 70 is being used, or may be sent at periodic intervals. This provides a method of confirming the remote module 60 remains associated with a particular load 70. However in some cases the confirmation can be expressed in the current and/or voltage monitoring to verify load 70's presence, or act as a holding circuit.

The power line connecting circuit control module 40 and remote module 60 may also be used to transmit codes, IDs and other information. In such cases a user could lock out power flow when unused while still allowing power line communication during use. In the case wherein addressable power circuits are used, such as those used in home automation; the power lock system according to the invention can use power line communication methods while not affecting communications between addressable power circuits.

Circuit control module 40 may be positioned in a central location where a single or multiple circuits can be controlled and monitored from a single circuit control module 40. Examples of this type of usage include parking lots with a dedicated circuit to each stall, and public areas like parks, RV and/or trailer parks.

Alternatively, circuit control module 40 may be built into an assembly possibly including a power source 10 and power receptacles 50. Examples where this embodiment may be used include outdoor/indoor residential receptacles, or commercial indoor/outdoor receptacles and other uses with a plurality of power receptacles 50 are connected to multiple circuits for random usage. Such an assembly may include a battery as the power source 10, and be portable for use in camping and other recreational purposes.

Circuit control module 40 may use power monitoring using power meter 350, typically in watts and typically by using current and potential or “voltage” transformers to measure and monitor loads 70. By monitoring the exact power consumption of a load 70 and comparing it to a pre coded power consumption value provided by a manufacturer, a pre calibrated power consumption value established by circuit control module 40, or a power consumption value manually provided, the loads 70 can be monitored and the connection to load 70 opened if a load 70 is in short circuit, open circuit, over current, under current, over voltage or under voltage. This helps circuit control module 40 determine if the connection to load 70 should be opened, for example, in emergency or backup power situations, or loads such as electrical controls for gas furnaces or water heaters, refrigerators, or even routers for Internet connectivity. The loads 70 that are being monitored and authorized by circuit control module 40 may also in this case be provided with safety circuits in multiple ways as described below.

For example, in one embodiment, power wiring in walls can be maintained at a low voltage state by circuit control module 40 until authorized for a specific load 70 via a remote module 60 associated with the load. This reduces the risk of short circuits in walls, cords and or loads as the specific loads are known in comparison to the power consumption being monitored. This also helps correct deficiencies in 15 amp circuit breakers, which have little control over small usage loads, and may short circuit, which is a typical cause of fires due to the shorted or damaged cords and/or interior wall wiring.

In another embodiment of the invention power receptacles 50 in walls may be maintained at a low voltage state until authorized by circuit control module 40. This reduces the risk of electrocution from unknown of foreign objects contacting power receptacle 50.

Circuit control module 40 may be capable of uploading/downloading software and transmitting software, instructions, information, and software updates to remote modules 60 to control, calibrate, sync, troubleshoot or for any other reason. Circuit control module 40 also may transmit notifications of emergencies, faults or needed repairs if detected, or for other required uses. Circuit control module 40 may communicate with remote module 60 to authorize and monitor the power usage of the given load 70.

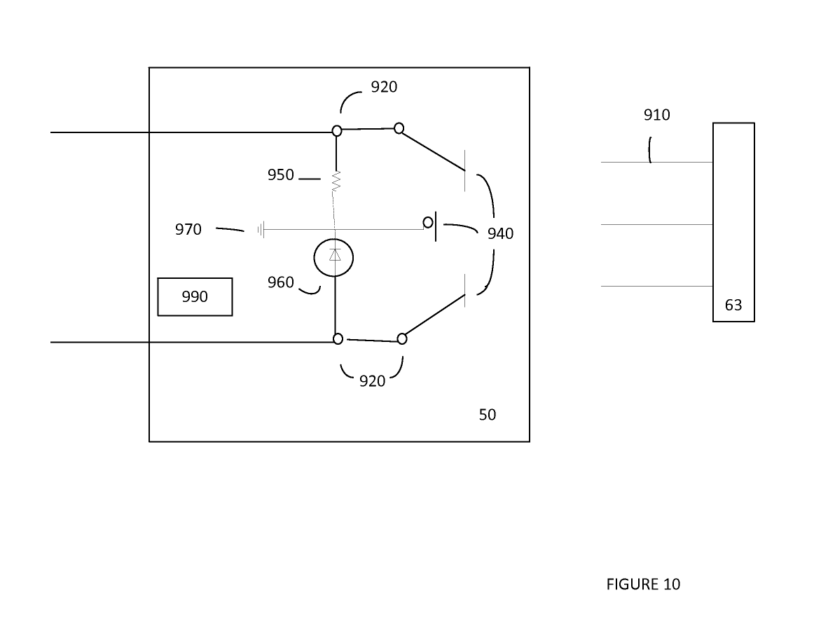

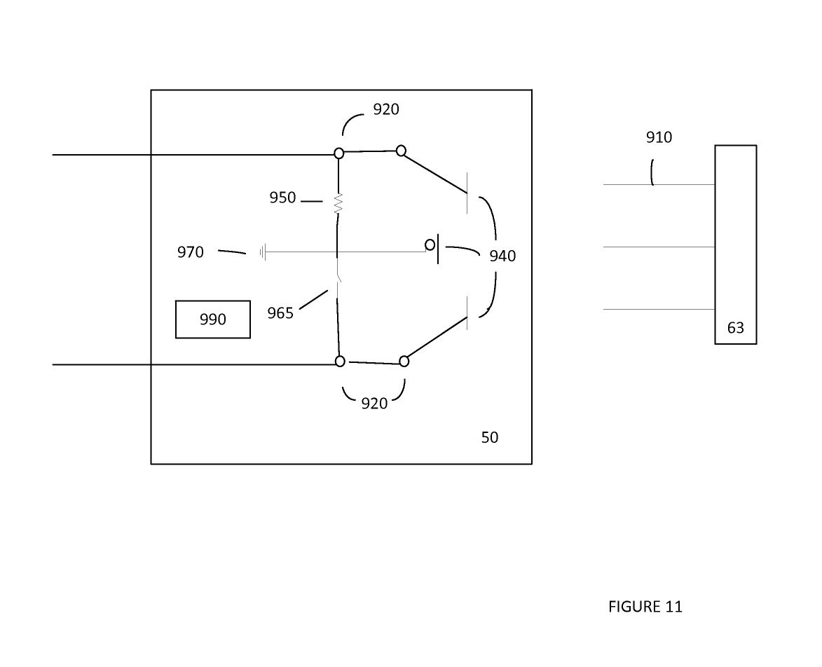

FIGS. 10 and 11 show embodiments of a circuit control system according to the invention to detect circuit faults throughout the entire circuit, such as open or short circuits. Plug 63 has three prongs 910 shaped and sized to be received by receptacle 50. Receptacle 50 includes contacts 940 to receive prongs 910. One of the contacts 940 is connected to ground 970. The other contacts 940 pass through nodes 920. One contact connects to resistor 950, the other to gated diode 960. In the embodiment shown in FIG. 11 electronic switch 965, for example controlled by microprocessor 990, will stop the flow of power past a predetermined level, for example 30 volts. Alternatively, as shown in FIG. 10 microprocessor 990 may control gated diode 960 to the same effect. Resistor 950 can be used to measure resistance and thereby detect circuit faults, such as an open or short circuit or if a circuit is near a fire, as the heat from a fire changes the resistance in the wire.

Remote module 60 may be precoded with authorized codes and/or manufactured specifications or may download the codes or specifications via the Internet or via circuit control module 40. Load 70 may be any item requiring or using power, and may be hard wired or wired through an outlet with a cord attachment. Remote module 60 may be built into load 70 or be a separate attachment which could be pre-coded or upload/download capable. In another embedment of the invention a system according to the invention may use smart circuits for back up, emergency power or other reasons, for example reducing utility usage. In this embodiment, power source 10 supplies power through a current protector which provides over current/short circuit protection and which may be either separate or part of the same unit as circuit control module 40. In some cases current the current protector and circuit control module 40 may be as simple as a smart circuit breaker installed into a distribution panel with a communication link of any sort.

Control module 40 may control for conditions in which limited power supplies are available. Such conditions could be, for example, when a power grid goes down or when a grid is at maximum capacity which the power source operator could communicate via the communication link to circuit control module 40. Circuit control module 40 then could control the actual loads being energized such as (and used solely for illustrative purposes) gas furnace electronic controls, gas water heater electronic control, refrigerators, LED lights, computer, Internet connectors, and input/output 370, which may include Ethernet, wireless, power line communications or other means. Existing grids could add back up generation, and/or private generation could activate the emergency load requirements as needed or preprogrammed.

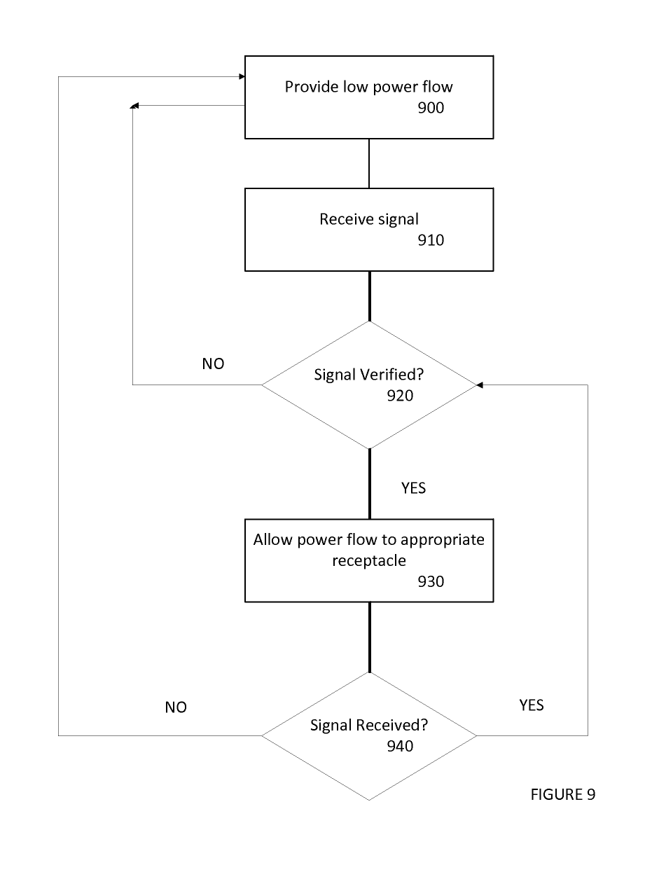

An embodiment of a method according to the invention is shown in FIG. 9. At step 900, circuit control module 40 provides low power flow from power source 10 to receptacle 50. At step 910 a signal is received from a remote module 60. At step 920, the signal is verified. If the signal is verified, at step 930 power flows to receptacle 50. If the signal is not verified, the method returns to step 900. After power flow has been increased at step 930, circuit control module 40 waits for the next signal from remote module 60. If the signal is not received timely, power flow is reduced at step 900, and if the signal is received and verified, power continues to flow.

An example of a use of the system would be in California, where planned power outages to areas of the grids have occurred. Using the system according to the invention power could be reduced to emergency usages only instead of cutting the power off completely, which may cause chaos, communication loss, wasted food, and frozen homes. Business, insurance and life costs would thereby be reduced. This would allow an emergency or backup or controlled power grid in which loads could be monitored, private and or utility power generation could be monitored and/or billed as emergency power if appropriate. This may provide a new market for backup generators in various sectors of utility grids with actual controllable usage for such generators which is linked directly to the system according to the invention for circuit control, monitoring and authorization.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention, or components thereof, can be practiced with other computing system configurations, including hand-held devices, multiprocessor systems, microprocessor-based or programmable consumer electronics, personal computers (“PCs”), network PCs, mini-computers, mainframe computers, mobile phones, smart phones, personal digital assistants, personal music players (like IPODs) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “module” is a computing system as described in the following. A computing system may include one or more processing units (e.g. processor), system memories, and system buses that couple various system components including system memory to a processor. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM or BLU-RAY, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known, including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a computer program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A power control system comprising:
a power control module comprising
a controller configured to change to and from a first state operable to enable an electrical connection between a power source and a power receptacle sufficient to operate a load, and a second state operable to limit the voltage to the power receptacle to a power level greater than zero volts but insufficient voltage to operate the load;
a receiver;
a processor, the processor configured to move the switch in response to a code received by the receiver from a transmitter associated with the load.

2. The power control system of claim 1 wherein when the controller is in the second state the power reaching the power receptacle is sufficient to operate the transmitter.

3. The power control system of claim 1 wherein the receiver is configured to receive the code wirelessly.

4. The power control system of claim 1 wherein the receiver is configured to receive the code over the electrical connection.

5. The power control system of claim 1 wherein the transmitter is powered by a battery.

6. The power control system of claim 1 wherein the transmitter is positioned within the load.

7. The power control system of claim 1 wherein the transmitter is positioned within an extension cord.

8. The power control system of claim 1 wherein the power control module is powered by the power source.

9. The power control system of claim 1 wherein the transmitter is powered by an electrical connection to the power source.

10. The power control system of claim 1 wherein the power control module further comprises a communications interface for communicating with a computing device.

11. The power control system of claim 1 wherein the power control module is configured to compare power consumed by a load receiving power through the receptacle to a predetermined power consumption level and if the predetermined power consumption level is exceeded disabling the electrical connection to the receptacle.

12. A power control system comprising
an electrical load comprising
a plug;
a transmitter, the transmitter configured to transmit a code to a receiver, the code associated with the load and the receiver associated with a module configured to allow power flow through a receptacle.

13. A power control system comprising:
an electrical load;
a transmitter associated with the electrical load, the transmitter configured to transmit a code associated with the electrical load;
a power control module comprising a switch, and a receiver, the power control module configured to operate the switch to connect a power source to the electrical load on receipt of the code.

14. A power control system comprising:
a plurality of electrical loads;
a connection to a first power source;
a connection to a second power source;
means to protect the power control system from overcurrent; and
a controller, the controller configured so that should the first power source cease controlling power, the controller will selectively energize at least one of the plurality of loads using the second power source based on predetermined criteria.

15. A power control system comprising:
a power distribution module comprising
a controller configured to electrically connect one or more power receptacles of a plurality of power receptacles, each switch configured to move from a first position operable to enable an electrical connection between a power source and the switch's corresponding power receptacle, and a second position operable to disable the connection between the power source and the switch's corresponding power receptacle;
a receiver;
a processor, the processor configured to move one of the plurality of switches in response to a code received by the receiver from a transmitter associated with a load corresponding to one of the plurality of power receptacles.

16. The power control system of claim 14 further comprising a metering module configured to monitor the power usage at each of said plurality of receptacles.
